(19) United States
(12) Patent Application Publication
(10) Pub. No.: US 2018/0200874 A1
(43) Pub. Date: Jul. 19, 2018

(54) Shock Absorption Device for Pneumatic Tool

(71) Applicant: Jhih Jhong Lin, Yilan County (TW)

(72) Inventor: Jhih Jhong Lin, Yilan County (TW)

(21) Appl. No.: 15/919,785

(22) Filed: Mar. 13, 2018

Related U.S. Application Data
(63) Continuation-in-part of application No. 14/662,297, filed on Mar. 19, 2015.

(51) Int. Cl. B25D 17/24; B25D 9/04

(52) U.S. Cl. CPC B25D 17/24; B25D 2250/371; B25D 2250/181; B25D 9/04

(57) ABSTRACT

A device absorbs shock in a pneumatic tool containing a body, a cylinder, a valve unit, a piston member, plural buffer springs, and multiple fitting sleeves. The body includes a grip and a fitting sleeve fitted with the grip. The fitting sleeve has a chamber, a close face formed on a first end thereof, and an opening formed on a second end thereof. Each fitting sleeve is hollow and includes a limitation length forming along a hollow extending direction and shorter than a largest length. Multiple positioning sleeves are defined between a close face of the fitting sleeve and an abutting portion of the cylinder, and the multiple positioning sleeves are hollow so as to accommodate plural buffer springs. Because the limitation length is shorter than the largest length, the plural buffer springs extend out of the multiple positioning sleeves respectively.

This application is a Continuation-in-Part of application Ser. No. 14/662,297, filed Mar. 19, 2015.

### BACKGROUND OF THE INVENTION

### Field of the Invention

The present invention relates to a shock absorption structure and, more particularly, to a shock absorption device for a pneumatic tool which reduces operating vibration.

### Description of the Prior Art

A conventional pneumatic tool is driven by high pressure air used as a power source. With reference to FIG. 10, the conventional pneumatic tool contains: a grip 10, a valve unit 20, a cylinder 30, and a piston member 40. The grip 10 includes an air inlet segment 101 connected with high pressure air, an air passage 102 communicating with the air inlet segment 101, a control switch (not shown) for controlling air to flow into the air inlet segment 101, and a cylindrical portion 103. The cylindrical portion 103 has a chamber 104 defined therein and communicating with the air passage 102. The valve unit 20 is mounted in the chamber 104 of the cylindrical portion 103, and one end of the cylinder 30 is inserted into the chamber 104 of the cylindrical portion 103, such that the cylinder 30 contacts with the valve unit 20. The cylinder 30 includes a room 301 defined therein and a flowing channel 302 formed between a front end of the room 301 and the valve unit 20. The flowing channel 302 is in communication with the front end of the room 301 and the valve unit 20, and the piston member 40 is accommodated and slides in the room 301 of the cylinder 30. When turning on the control switch on the grip 10, the high pressure air flows into the valve unit 20 in the chamber 104 of the cylindrical portion 103 from the air inlet segment 101 of the grip 10 via the air passage 102, and the valve unit 20 controls the high pressure air flowing into the room 301 of the cylinder 30 to push the piston member 40 toward a predetermined position. Thus a tool head (not shown) is hit by the piston member 40, and the tool head stops the piston member 40. Thereafter the valve unit 20 controls the high pressure air to flow into a front end of the room 301 of the cylinder 30 through the flowing channel 302, such that the piston member 40 is pushed by the high pressure air to slide backward to impact the valve unit 20. Hence the piston member 40 is stopped by the valve unit 20, thus moving the piston member 40 back and forth to operate the pneumatic tool.

However, when the piston member 40 slides backward to impact the valve unit 20, a reaction force produces and passes toward the user's hand, thus making gripping the pneumatic tool difficult and hurting the user's waist easily.

To overcome above-mentioned problem, a spring is fixed in the chamber of the cylindrical portion, such that the spring cushions the impact force when the piston member 40 slides backward to impact the valve unit 20, thereby decreasing the reaction force which passes toward the user's hand. But when the piston member 40 hits the spring, the spring is pressed extremely, and the piston member 40 of the conventional pneumatic tool impacts frequently and quickly, hence the spring causes fatigues and is broken, thus replacing the spring troublesomely.

The present invention has arisen to mitigate and/or obviate the afore-described disadvantages.

### SUMMARY OF THE INVENTION

The primary objective of the present invention is to provide a shock absorption device for a pneumatic tool in which plural buffer springs are accommodated in a chamber of a fitting sleeve, and the plural buffer springs extend out of multiple positioning sleeves respectively so that the multiple positioning sleeves separate and fix the plural buffer springs individually to scatter and to buffer reaction force evenly, thus having multiple shock absorption; when the plural buffer springs press the multiple positioning sleeves at the limitation length individually, the multiple positioning sleeves limit the plural buffer springs to be pressed continuously so as to avoid excessive compression of the plural buffer springs, thus prolonging service life of the plural buffer springs. Preferably, the plural buffer springs buffer the reaction force, such that the shock is absorbed and the reaction force which passes to the user's hand is reduced, thus operating the pneumatic tool easily and protecting the user's wrist.

To obtain above-mentioned objective, a shock absorption device for a pneumatic tool provided by the present invention contains: a body, a cylinder, a valve unit, a piston member, plural buffer springs, and multiple positioning sleeves.

The body includes a grip and a fitting sleeve fitted with the grip. The fitting sleeve has a chamber defined therein, a close face formed on a first end thereof, and an opening formed on a second end thereof.

The cylinder is slidably fixed in the chamber of the fitting sleeve and a part thereof extends out of the opening of the fitting sleeve. The cylinder includes a room defined therein and an abutting portion adjacent to the close face of the chamber of the fitting sleeve.

The valve unit is fixed between the room and the abutting portion of the cylinder.

The piston member is accommodated in the room of the body and slides forward and backward along a movement axis. Plural buffer springs are accommodated in the chamber of the fitting sleeve and abut against the close face of the chamber of the fitting sleeve and the abutting portion of the cylinder. A pressing direction of each buffer spring is parallel to the movement axis of the piston member, and plural elastic supporting points are formed between the close face and the abutting portion so that when the plural buffer springs do not press, a largest length forms.

Each of the multiple positioning sleeves is hollow and includes a limitation length forms along a hollow extending direction, the limitation length is shorter than the largest length, the multiple positioning sleeves are defined between the close face of the chamber of the fitting sleeve and the abutting portion of the sliding sleeve of the cylinder, and the multiple positioning sleeves are hollow so as to accommodate the plural buffer springs; because the limitation length is shorter than the largest length, the plural buffer springs extend out of the multiple positioning sleeves respectively.

### BRIEF DESCRIPTION OF THE DRAWINGS

FIG. 1 is a perspective view showing the assembly of a pneumatic tool according to a preferred embodiment of the present invention.

FIG. 2 is a perspective view showing the exploded components of the pneumatic tool according to the preferred embodiment of the present invention.

FIG. 3 is a cross sectional view showing the assembly of the pneumatic tool according to the preferred embodiment of the present invention.

FIG. 4 is a cross sectional view taken along the line A-A of FIG. 3 according to the preferred embodiment of the present invention.

FIG. 5 is an amplified cross sectional view of a portion B of FIG. 3.

FIG. 6 is a cross sectional view showing the operation of the pneumatic tool according to the preferred embodiment of the present invention.

FIG. 7 is another cross sectional view showing the operation of the pneumatic tool according to the preferred embodiment of the present invention.

FIG. 8 is also another cross sectional view showing the operation of the pneumatic tool according to the preferred embodiment of the present invention.

FIG. 9 is an amplified cross sectional view of a portion C of FIG. 8.

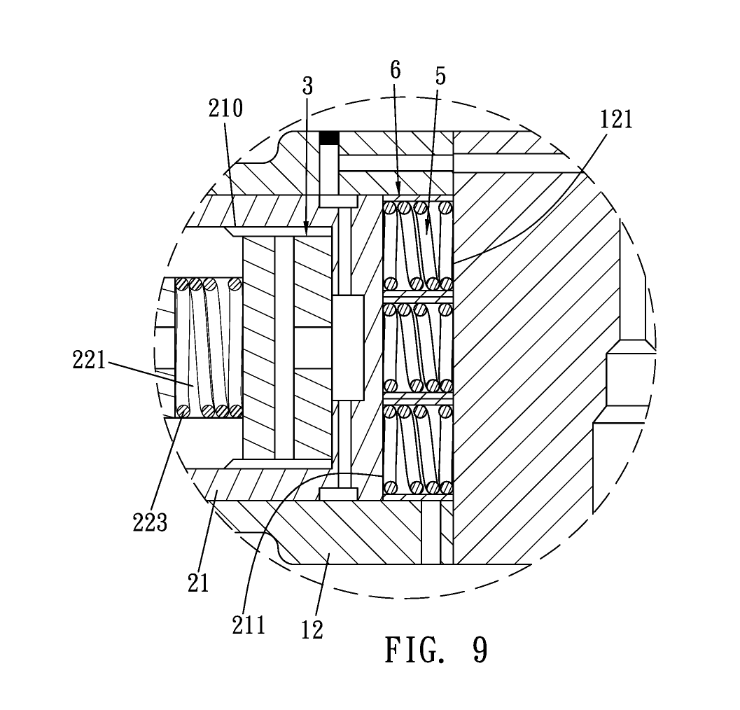

FIG. 10 is a cross sectional view of a conventional pneumatic tool.

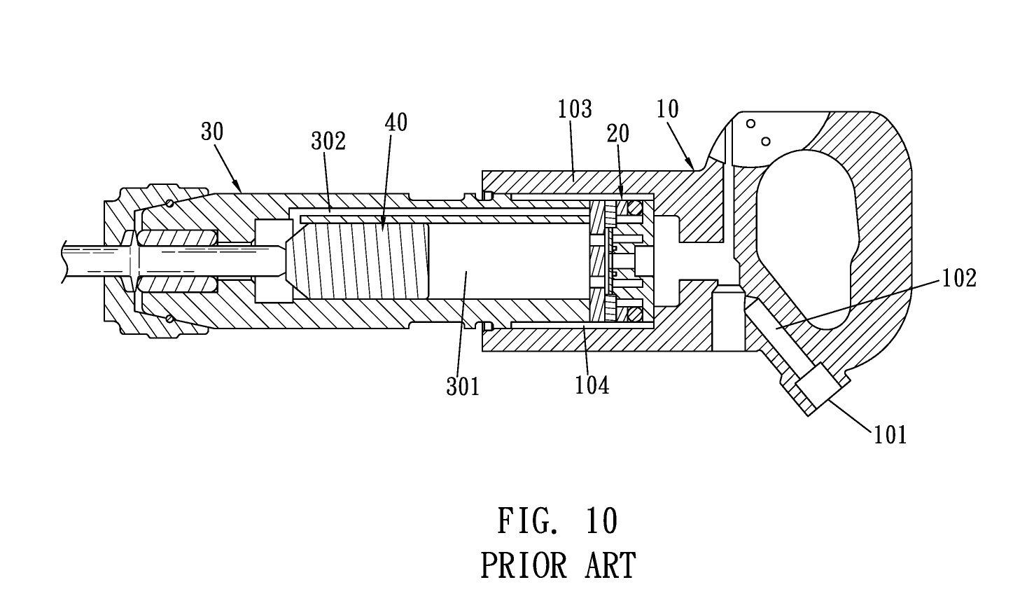

### DETAILED DESCRIPTION OF THE PREFERRED EMBODIMENTS

The present invention will be clearer from the following description when viewed together with the accompanying drawings, which show, for purpose of illustration only, preferred embodiments in accordance with the present invention.

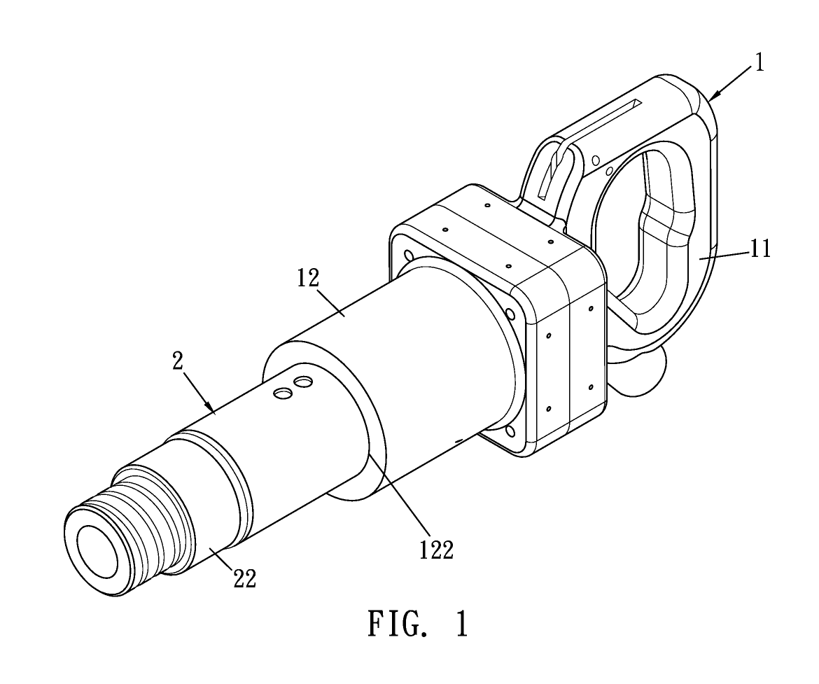

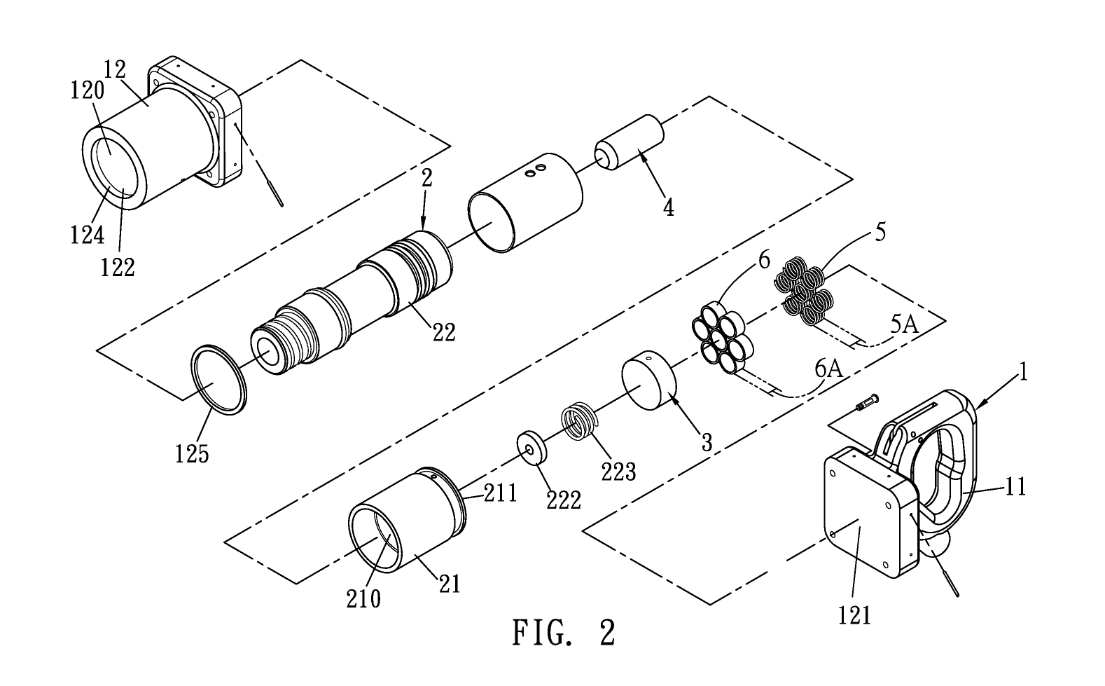

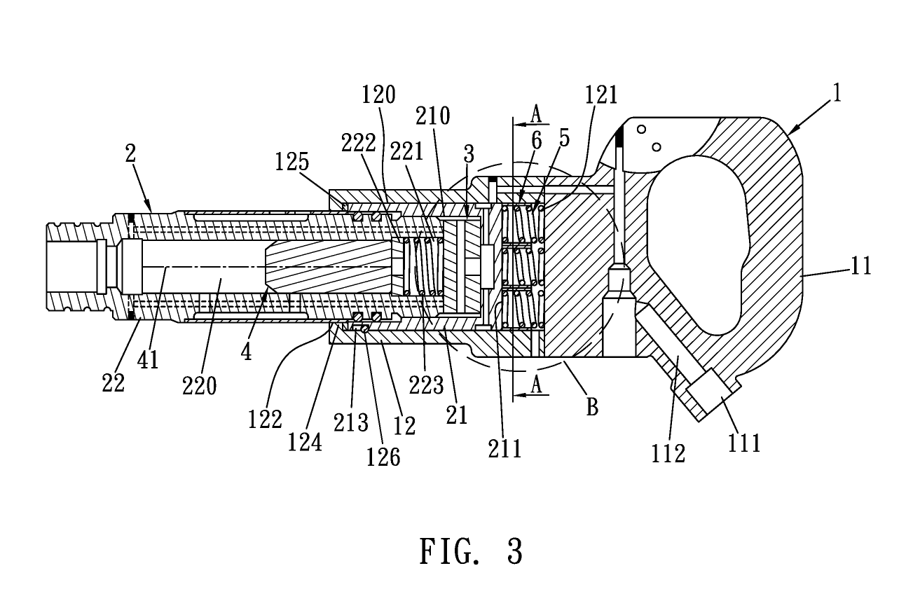

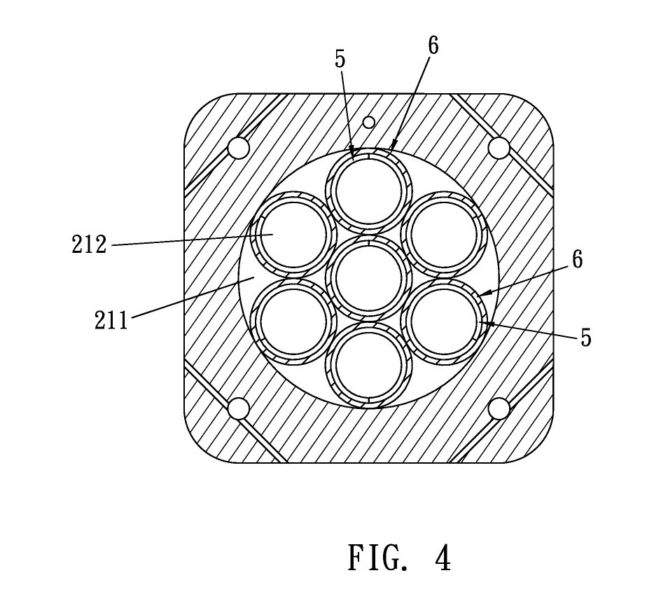

FIGS. 1 to 5 show a shock absorption device for a pneumatic tool according to a preferred embodiment of the present invention. The pneumatic tool comprises: a body 1, a cylinder 2, a valve unit 3, a piston member 4, plural buffer springs 5, and multiple positioning sleeves 6. The body 1 includes a grip 11 and a fitting sleeve 12 fitted with the grip 11. The grip 11 has an air inlet segment 111, an air passage 112 communicating with the air inlet segment 111, and a control switch (not shown) for controlling air to flow into the air inlet segment 111. The fitting sleeve 12 has a chamber 120 defined therein, a close face 121 formed on a first end thereof, an opening 122 formed on a second end thereof, and a stop rib 124 extending inwardly from a peripheral side of the opening 122.

The cylinder 2 includes a sliding sleeve 21 and a base 22, wherein the sliding sleeve 21 is slidably fitted in the chamber 120 of the fitting sleeve 12, and the sliding sleeve 21 has a hollow portion 210 formed therein, an abutting portion 211 adjacent to the close face 121 of the chamber 120 of the fitting sleeve 12. The sliding sleeve 21 is stopped by a washer 125 for matching with the stop rib 124 of the fitting sleeve 12, and the sliding sleeve 21 has a limiting slot 213 defined on an outer side thereof to insert a defining element 126 of the fitting sleeve 12, wherein one end of the base 22 is inserted into the hollow portion 210 of the sliding sleeve 21 and is connected with the sliding sleeve 21 in a screwing manner, a part of the base 22 extends out of the opening 122 of the chamber 120 of the fitting sleeve 12, and the base 22 has a room 220 defined therein, the room 220 has an expanding groove 221 formed on a rear end thereof, the expanding groove 221 has a circular moving element 222 and a compression spring 223.

The valve unit 3 is fixed between the room 220 and the abutting portion 211 of the cylinder 2, such that high pressure air flows toward the valve unit 3 via the air passage 112 of the grip 11.

The piston member 4 is accommodated in the room 220 of the base 22 and slides forward and backward along a movement axis 41.

The plural buffer springs 5 are circularly mounted in the chamber 120 of the fitting sleeve 12 and abut against the close face 121 of the chamber 120 of the fitting sleeve 12 and the abutting portion 211 of the sliding sleeve 21 of the cylinder 2, wherein a pressing direction of each buffer spring 5 is parallel to the movement axis 41 of the piston member 4, and plural elastic supporting points form between the close face 121 and the abutting portion 211 so that when the plural buffer springs 5 do not press, a largest length 5A forms.

Each of the multiple positioning sleeves 6 is hollow and includes a limitation length 6A forms along a hollow extending direction, wherein the limitation length 6A is shorter than the largest length 5A, the multiple positioning sleeves 6 are defined between the close face 121 of the chamber 120 of the fitting sleeve 12 and the abutting portion 211 of the sliding sleeve 21 of the cylinder 2, and the multiple positioning sleeves 6 are hollow so as to accommodate the plural buffer springs 5. Because the limitation length 6A is shorter than the largest length 5A, the plural buffer springs 5 extend out of the multiple positioning sleeves 6 respectively so that the multiple positioning sleeves 6 separate and fix the plural buffer springs 5 individually.

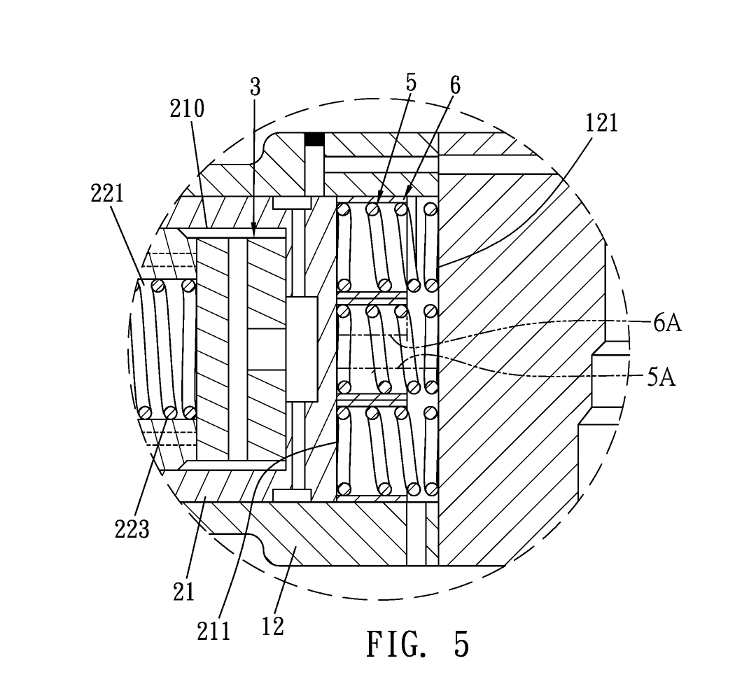

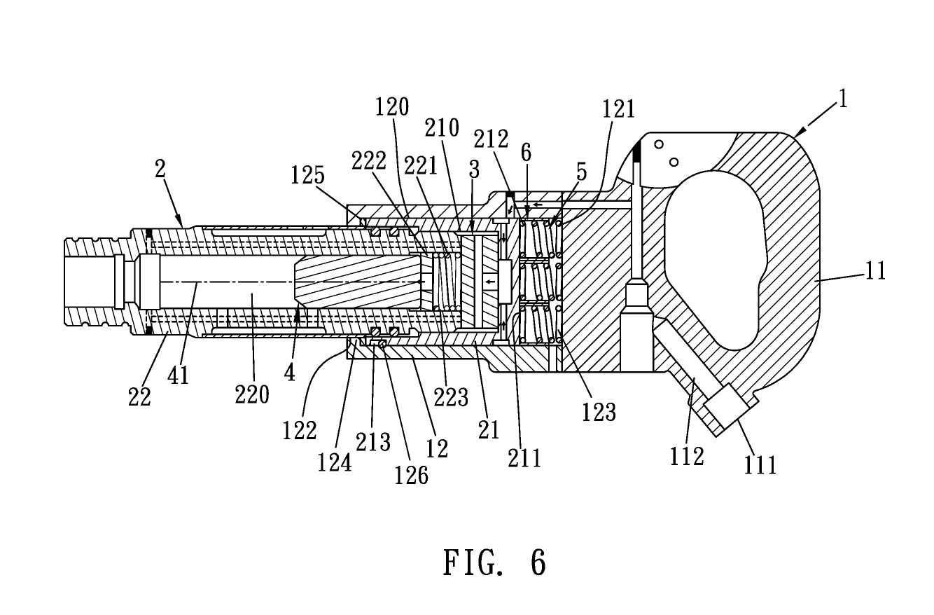

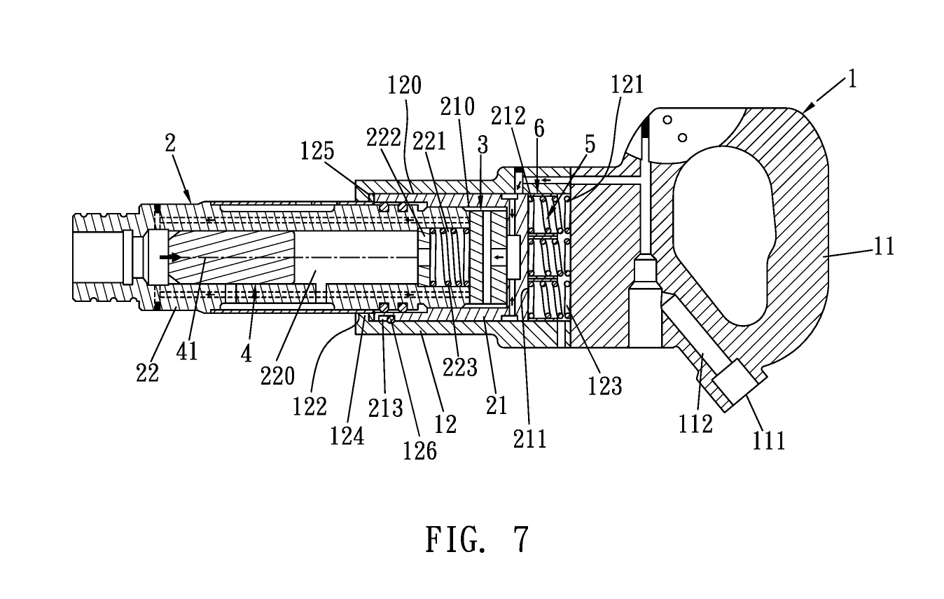

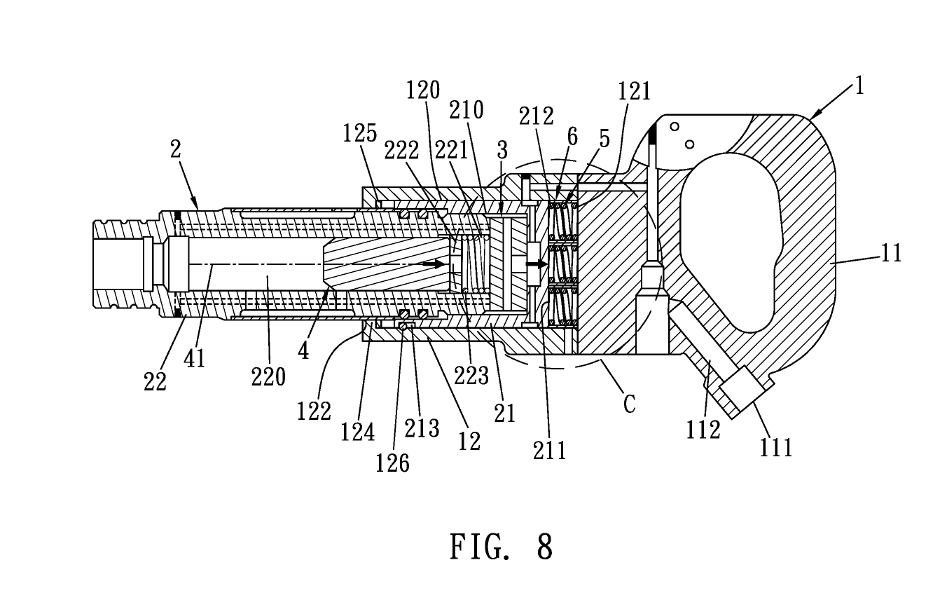

After the control switch on the grip 11, as shown in FIGS. 5 and 6, is turned on, the high pressure air flows into the valve unit 3 through the air passage 112 of the grip 11. Then the high pressure air flows into the room 220 of the base 22 from the valve unit 3 to push the piston member 4 to slide toward a front end of the room 220, such that a tool head (not shown) is hit by the piston member 4, and the piston member 4 is stopped by the tool head, as shown in FIGS. 7 and 8. Thereafter the high pressure air flows into the room 220 of the cylinder 2 through the valve unit 3 to push the piston member 4 to move toward a rear end of the room 220. Then the piston member 4 hits the valve unit 3 so that the cylinder 2 is driven to move backward. The plural buffer springs 5 are biased against the close face 121 of the chamber 120 of the fitting sleeve 12 and the abutting portion 211 of the sliding sleeve 21 of the cylinder 2 to disperse and to buffer a reaction force, thus absorbing shock. When the cylinder 2 moves backward to impact the plural buffer springs 5, the plural buffer springs 5 press the multiple positioning sleeves 6 at the limitation length 6A, the multiple positioning sleeves 6 limit the plural buffer springs 5 to be pressed respectively so as to prolong service life of the plural buffer springs 5 and to reduce the reaction force to pass toward the user's hand and to push the piston member 4 forward and backward

Accordingly, the shock absorption device of the present invention has advantages as follows:

The shock absorption device of the present invention contains the plural buffer springs 5 which are accommodated in the chamber 120 of the fitting sleeve 12, and the plural buffer springs 5 extend out of the multiple positioning sleeves 6 respectively so that the multiple positioning sleeves 6 separate and fix the plural buffer springs 5 individually to scatter and to buffer reaction force evenly, thus having multiple shock absorption. When the plural buffer springs 5 press the multiple positioning sleeves 6 at the limitation length 6A individually, the multiple positioning sleeves 6 limit the plural buffer springs 5 to be pressed continuously so as to avoid excessive compression of the plural buffer springs 5, thus prolonging service life of the plural buffer springs 5. Preferably, the plural buffer springs 5 buffer the reaction force, such that the shock is absorbed and the reaction force which passes to the user's hand is reduced, thus operating the pneumatic tool easily and protecting the user's wrist.

While various embodiments in accordance with the present invention have been shown and described, it is clear to those skilled in the art that further embodiments may be made without departing from the scope of the present invention.

What is claimed is:

1. A shock absorption device for a pneumatic tool, wherein a pneumatic tool comprises:
a body including a grip and a fitting sleeve fitted with the grip, with the fitting sleeve having a chamber defined therein, a close face formed on a first end thereof, and an opening formed on a second end thereof;
a cylinder slidably fixed in the chamber of the fitting sleeve and a part thereof extending out of the opening of the fitting sleeve, with the cylinder including a room defined therein and an abutting portion adjacent to the close face of the chamber of the fitting sleeve;
a valve unit fixed between the room and the abutting portion of the cylinder;
a piston member accommodated in the room of the body and sliding forward and backward along a movement axis;
plural buffer springs mounted in the chamber of the fitting sleeve and abutting against the close face of the chamber of the fitting sleeve and the abutting portion of the cylinder, wherein a pressing direction of each buffer spring is parallel to the movement axis of the piston member, and plural elastic supporting points form between the close face and the abutting portion so that when the plural buffer springs do not press, a largest length forms; and
multiple positioning sleeves is hollow and includes a limitation length forms along a hollow extending direction, the limitation length is shorter than the largest length, the multiple positioning sleeves are defined between the close face of the chamber of the fitting sleeve and the abutting portion of the sliding sleeve of the cylinder, and the multiple positioning sleeves are hollow so as to accommodate the plural buffer springs; hence the limitation length is shorter than the largest length, the plural buffer springs extend out of the multiple positioning sleeves respectively.

2. The shock absorption device for the pneumatic tool as claimed in claim 1, wherein a stop rib extends inwardly from a peripheral side of the opening, and the cylinder is stopped by the stop rib of the fitting sleeve for matching with a washer.

3. The shock absorption device for the pneumatic tool as claimed in claim 1, wherein the cylinder includes a sliding sleeve and a base, wherein the sliding sleeve is slidably fitted in the chamber of the fitting sleeve, and the sliding sleeve has a hollow portion formed therein, wherein the abutting portion of the cylinder is fixed on one end of the hollow portion adjacent to the close face of the chamber of the fitting sleeve, and one end of the base is inserted into the hollow portion of the sliding sleeve and is connected with the sliding sleeve in a screwing manner.

4. The shock absorption device for the pneumatic tool as claimed in claim 3, wherein the sliding sleeve has a limiting slot defined on an outer side thereof to insert a defining element of the fitting sleeve.
